(19) United States
(12) Patent Application Publication
(10) Pub. No.: US 2012/0068028 A1
(43) Pub. Date: Mar. 22, 2012

(54) BEVERAGE HOLDER FOR POOL NOODLE

(76) Inventors: Kent M. ARNOLD, Cincinnati, OH (US); William Patrick Youngblood, Hartsville, SC (US)

(21) Appl. No.: 13/227,914

(22) Filed: Sep. 8, 2011

Related U.S. Application Data
(60) Provisional application No. 61/383,389, filed on Sep. 16, 2010.

(51) Int. Cl. A44B 18/00; A44B 13/00; F16B 17/00; A47G 29/00; H01F 7/02

(52) U.S. Cl. 248/205.2; 248/224.8; 248/206.5; 403/375; 24/303; 24/592.1; 403/364

(57) ABSTRACT

A beverage device comprising a beverage holder having an upper end and a lower end with the lower end having a beverage holder connector. A beverage holder support has a connecting end and a locking end. The locking end has a protruding portion having an outside diameter sized to fit inside a pool noodle and an annular wall having an inside diameter sized to fit around the pool noodle. The connecting end has a beverage holder support receiver for receiving the beverage holder connector.

### CROSS-REFERENCE TO RELATED APPLICATION

This application claims the benefit of U.S. Provisional Patent Application No. 61/383,389 filed on Sep. 16, 2010, the disclosures of which are incorporated by reference.

### FIELD OF THE INVENTION

This invention relates generally to a beverage device for use with a pool noodle. More particularly, this invention relates to a beverage device with mechanisms for attaching the beverage device to a variety of bases.

### BACKGROUND OF THE INVENTION

Various beverage devices typically used for holding coffee or other beverages are known. Pool noodles, commonly 2-4 inches in diameter, are often used by swimmers and boaters to provide recreational flotation while floating in the water. While floating on a pool noodle, a user often holds a beverage in a hand. Combining a pool noodle with a detachable beverage holder frees up a user's hands and provides a convenient location for storing a beverage holder. A beverage device mountable to a pool noodle is desired.

### SUMMARY OF THE INVENTION

The present invention relates to a beverage device comprising a beverage holder having an upper end and a lower end, the lower end having a beverage holder connector, and a beverage holder support having a connecting end and a locking end, the locking end having a protruding portion having an outside diameter sized to fit inside a pool noodle and an annular wall having an inside diameter sized to fit around an outer surface of the pool noodle, and the connecting end having a beverage holder receiver for receiving the beverage holder connector.

The present invention further relates to a beverage device comprising a beverage holder having an upper end and a lower end, a beverage holder support having a connecting end and a locking end, the locking end having a protruding portion having an outside diameter sized to fit inside of a pool noodle and an annular wall having an inside diameter sized to fit around a pool noodle, and a cord, typically an elastic cord, connecting the beverage holder support to the beverage holder.

The present invention further relates to a recreational device comprising a recreational accessory having a lower end, the lower end having a recreational accessory connector, and a beverage holder support having a connecting end and a locking end, the locking end having a protruding portion having an outside diameter sized to fit inside a pool noodle and an annular wall having an inside diameter sized to fit around an outer surface of the pool noodle, and the connecting end having a beverage holder receiver for receiving the recreational accessory connector.

### BRIEF DESCRIPTION OF THE DRAWINGS

FIG. 1 is a section view of one embodiment of a beverage holder support of the invention.

FIG. 2 is a section view of a beverage holder support locking mechanism of the invention.

FIG. 3 is a side view of a beverage holder support, pool noodle, and beverage holder of the invention.

FIG. 4 is a side view of another embodiment of a beverage holder support, pool noodle, and beverage holder of the invention.

### DETAILED DESCRIPTION OF THE INVENTION

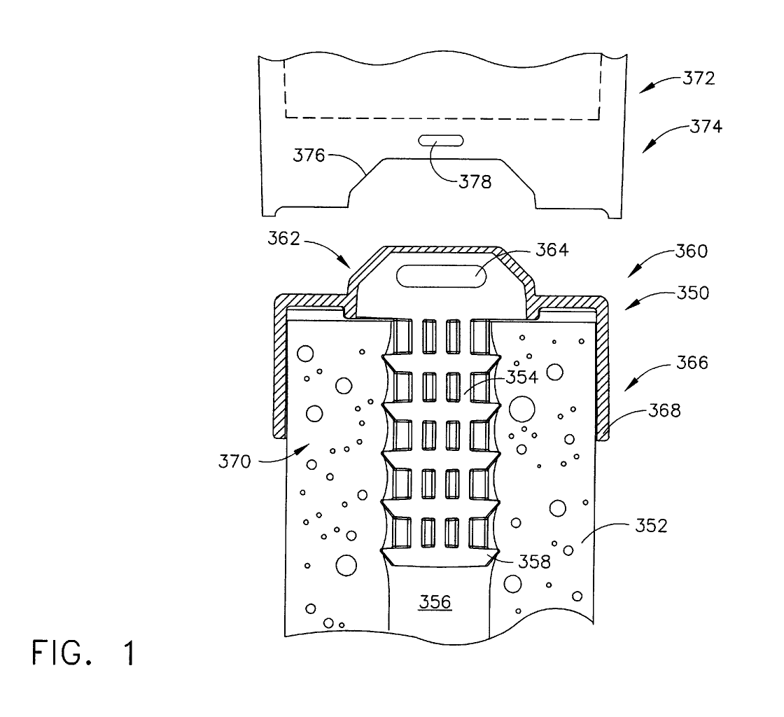

FIG. 1 shows one embodiment of a beverage holder support. A pool noodle beverage holder support 350 has a connecting end 360 and a locking end 366 and is designed to fit on the end of a conventional pool noodle 352. The locking end 366 has a protruding portion 354 with an outside diameter sized to fit the internal cavity 356 of the pool noodle 352. Typically, the pool noodle is made of a conventional material, such as low density foam, which is softer than the material used to make the beverage holder support. The protruding portion 354 may also have an annular barb 358, or multiple barbs, to secure the pool noodle beverage holder support 350 to the pool noodle 352. The barbs may be individual circumferential barbs, as shown in FIG. 1, or they may form a helical coil to allow the beverage holder support 350 to be screwed onto and off of the pool noodle. A locking end 366 of the pool noodle beverage holder support 350 may also have an annular wall 368 with an inside diameter sized to fit an outer surface of an upper end 370 of the pool noodle to assist with securing the beverage holder support to the pool noodle.

The connecting end 360 of the pool noodle beverage holder support 350 includes a beverage holder receiver 362 with a ferrous component 364. A beverage holder 372 has an upper end and a lower end 374, with the lower end having a beverage holder connector 376 that is received by the beverage holder receiver. The beverage holder connector has a magnetic component 378 that detachably affixes the beverage holder 372 to the beverage holder support 350 when the connector 376 is received by the receiver 362 and the magnetic component 378 engages the ferrous component 364. The beverage holder may be any one of a variety of beverage holders, such as a plastic shell designed to hold a foam thermally insulated drink holder 378, a mug, or a cup.

When magnets are used, typically they are permanent magnets, and more typically, magnets that retain a substantial amount of their magnetism over a period of time such as five years. Also, the magnets may be installed in different configurations. For example, the magnet may be included in the beverage holder support and the ferrous component may be included in the beverage holder. Additionally, a magnet may be included in the beverage holder support and another magnet may be included in the beverage holder. When two magnets are used, the magnets are orientated in their respective components so that the opposite poles of the magnets face each other and attract one another.

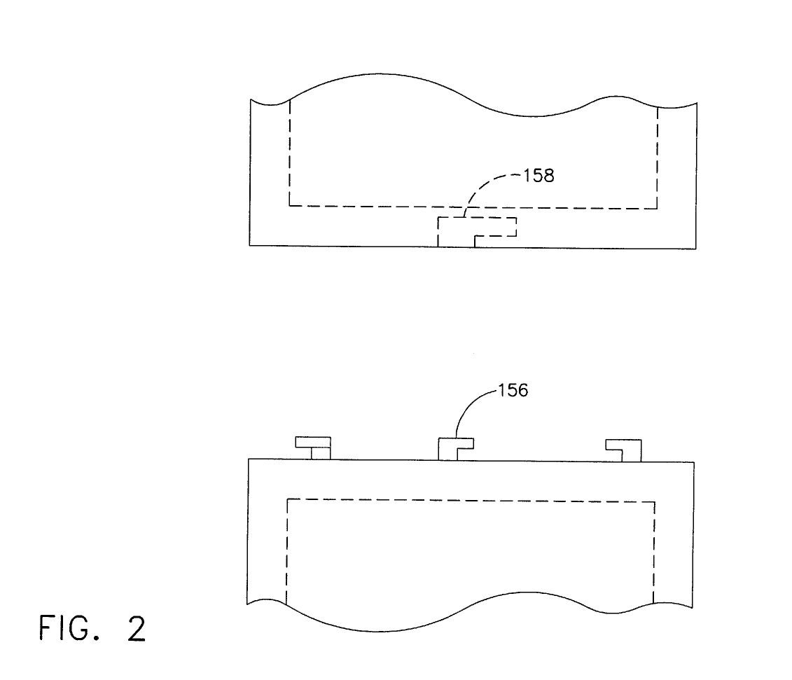

Other methods may also be used to connect the mug component to the beverage holder support. For instance, a twist lock mechanism as shown in FIG. 2 may also be used. The twist lock mechanism has a plurality of L-shaped locking tabs 156 upwardly projecting from the upper end of the beverage holder support that mate with a plurality of corresponding plurality of locking tab receiving slots 158 located on the lower end 108 of the outer shell 102 of the mug component 100. Additionally, a hook and loop connector, such as Velcro™, may be used as a method of connecting the beverage holder support 300 to the beverage holder. The beverage holder may have the hook portion of the hook and loop connector, and the beverage holder support may have the loop portion of the hook and loop connector. Alternatively, the beverage holder may have the loop portion of the hook and loop connector, and the beverage holder support may have the hook portion of the hook and loop connector.

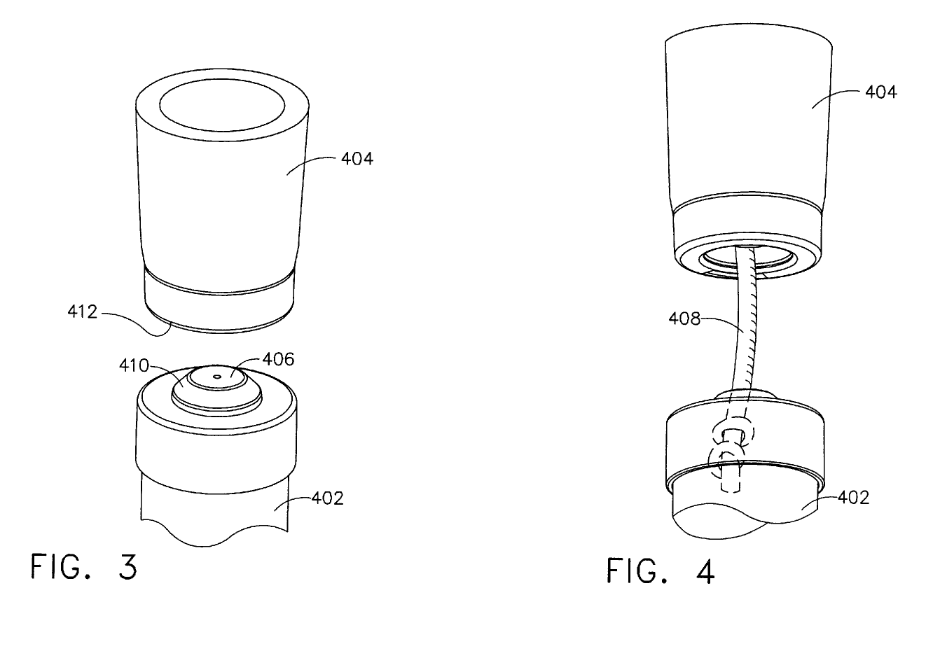

FIGS. 3 and 4 show other embodiments of a pool noodle beverage holder and a beverage holder support. Shown is a noodle 402 which is made out of a low-density synthetic resin material, such as extruded polyethylene. It is typically cylindrical in shape. Attached to the end of the noodle is a beverage holder 404. The beverage holder 404 may be made from the same materials as the noodle itself, it may be made from a hard plastic adapted to receive a thermally insulated beverage holder, or it may be made from other suitable materials. The beverage holder may be attached by several methods. In the first variation shown in FIG. 3, the beverage holder is fully detachable and held in place at the end of the noodle using a magnet 406. A typical diameter used with a beverage holder is between three and four inches, and more typically between 3¼ and 3¾ inches Another variation may include a male/female connection made of the same material as the noodle and beverage holder. The piece 410 may protrude from the noodle and can be fitted into a small female opening 412 on the bottom of the beverage holder. Hook and loop fasteners may also be used to attach the beverage holder to the noodle. There may also be the option to purchase the beverage holder separately and attach it to an existing pool noodle using a simple plastic ring at the bottom that would be of a circumference slightly larger than a standard noodle. This would allow the beverage holder to fit over the end of the noodle. Also, it may be possible to lock the beverage holder in place by rotating it on the end of the noodle using the twist lock mechanism described earlier. It can be rotated in the opposite direction to be unlocked. The product may be available in a variety of colors. The product may also be available in a variety of diameters to provide more flotation to accommodate larger consumers. The noodle is typically between two and four inches in diameter.

In a second variation shown in FIG. 4, an elastic cord 408 is included so that the beverage holder can be temporarily removed from the beverage holder support of the noodle, thereby stretching the elastic cord 408. The cord could be an elastic cord that is in tension when the beverage holder rests on top of the beverage holder support, thereby holding the beverage holder to the beverage holder support. Alternatively, it could be a non-elastic cord that prevents the noodle and the beverage holder from separating and floating apart. The cord shown in FIG. 4 is an elastic cord shown in an extended, or stretched, position so it will provide tension to hold the beverage holder in place when it is returned to the beverage holder support. Various lengths of cord may be used, depending on the distance from the noodle that the user wants to remove the beverage holder. Thus, a longer cord may be used to provide a greater distance and a shorter cord may be used to provide a shorter distance.

Additionally, the beverage holder support may also be used to support an item other than a beverage holder. For example, the beverage holder support may be used to hold a recreational accessory such as a squirt gun, umbrella, or action figure, among others. When a recreational accessory is used, a lower end of the recreational accessory is adapted in a manner similar to the lower end of a beverage holder, thereby having a recreational accessory connector that is received by the beverage holder receiver. The various methods described above for connecting a beverage holder to a beverage holder support, such as magnets, twist lock, Velcro, and an elastic cord may also be used to connect a recreational accessory to a beverage holder support.

While the present invention has been illustrated by the description of embodiments thereof, and while the embodiments have been described in considerable detail, it is not intended to restrict or in any way limit the scope of the appended claims to such detail. Additional advantages and modifications will be readily apparent to those skilled in the art. The invention is therefore not limited to the specific details, representative apparatus and method, and illustrated examples shown and described. Accordingly, departures may be made from such details without departing from the scope or spirit of the invention.

What is claimed is:

1. A beverage device comprising:
a. a beverage holder having an upper end and a lower end, the lower end having a beverage holder connector, and
b. a beverage holder support having a connecting end and a locking end, the locking end having a protruding portion having an outside diameter sized to fit inside a pool noodle and an annular wall having an inside diameter sized to fit around an outer surface of the pool noodle, and the connecting end having a beverage holder receiver for receiving the beverage holder connector.

2. The beverage device according to claim 1 wherein the beverage holder receiver includes a magnet and the beverage holder connector includes a ferrous component.

3. The beverage device according to claim 1 wherein the beverage holder receiver includes a ferrous component and the beverage holder connector includes a magnet.

4. The beverage device according to claim 1, wherein the beverage holder receiver includes a magnet and the beverage holder connector includes a magnet.

5. The beverage device according to claim 1, wherein the beverage holder receiver is a plurality of upwardly projecting locking tabs and the beverage holder connector is a corresponding plurality of locking tab receiving slots.

6. The beverage device according to claim 1, wherein the beverage holder receiver is a loop portion of a hook and loop connector and the beverage holder connector is a hook portion of a hook and loop connector.

7. The beverage device according to claim 1, wherein the beverage holder receiver is a hook portion of a hook and loop connector and the beverage holder connector is a loop portion of a hook and loop connector.

8. The beverage device according to claim 1, wherein the beverage holder is a drink holder.

9. The beverage device according to claim 8, wherein the drink holder is an insulated drink holder.

10. A beverage device comprising:
a. a beverage holder having an upper end and a lower end,
b. a beverage holder support having a connecting end and a locking end, the locking end having a protruding portion having an outside diameter sized to fit inside of a pool noodle and an annular wall having an inside diameter sized to fit around a pool noodle, and
c. an elastic cord connecting the beverage holder support to the beverage holder.

11. The beverage device according to claim 10, wherein the beverage holder is a drink holder.

12. The beverage device according to claim 11, wherein the drink holder is an insulated drink holder.

13. A recreational device comprising:
a. a recreational accessory having a lower end, the lower end having a recreational accessory connector, and
b. a beverage holder support having a connecting end and a locking end, the locking end having a protruding portion having an outside diameter sized to fit inside a pool noodle and an annular wall having an inside diameter sized to fit around an outer surface of the pool noodle, and the connecting end having a beverage holder receiver for receiving the recreational accessory connector.

14. The recreational device according to claim 13, wherein the recreational accessory is selected from the group consisting of a squirt gun, an umbrella, and an action figure.

15. The recreational device according to claim 13 wherein the beverage holder receiver includes a magnet and the recreational accessory connector includes a ferrous component.

16. The recreational device according to claim 13 wherein the beverage holder receiver includes a ferrous component and the recreational accessory connector includes a magnet.

17. The recreational device according to claim 13, wherein the beverage holder receiver includes a magnet and the recreational accessory connector includes a magnet.

18. The recreational device according to claim 13, wherein the beverage holder receiver is a plurality of upwardly projecting locking tabs and the recreational accessory connector is a corresponding plurality of locking tab receiving slots.

19. The recreational device according to claim 13, wherein the beverage holder receiver is a loop portion of a hook and loop connector and the recreational accessory connector is a hook portion of a hook and loop connector.

20. The recreational device according to claim 13, wherein the beverage holder receiver is a hook portion of a hook and loop connector and the recreational accessory connector is a loop portion of a hook and loop connector.
